(19) United States
(12) Patent Application Publication
(10) Pub. No.: US 2004/0253019 A1
(43) Pub. Date: Dec. 16, 2004

(54) Image forming apparatus

(76) Inventors: Kenji Asuwa, Toride (JP); Toru Miyasaka, Tsuchiura (JP); Masahiro Yagi, Kashiwa (JP); Shintaro Yamada, Chiyoda (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/679,338

(22) Filed: Oct. 7, 2003

(30) Foreign Application Priority Data
Oct. 7, 2002 (JP) 2002-293158

(51) Int. Cl. G03G 15/00

(52) U.S. Cl. 399/116; 399/118

(57) ABSTRACT

An image forming apparatus includes an image carrier having a photosensitive material on a surface thereof, a light scanning apparatus for irradiating scanning light on the image carrier in accordance with image information and a scanning light reflecting mirror for changing a traveling direction of the scanning light. The scanning light reflecting mirror and the image carrier are mounted on a common supporting member to constitute a first unit, and the light scanning apparatus is built into a second unit separate from the first unit.

### BACKGROUND OF THE INVENTION

1. Fielde of the Invention

The present invention relates to an image forming apparatus which forms an image by irradiating an image carrier with scanning light.

2. Description of the Prior Art

Conventionally, there is widely known an electrophotographic type of image forming apparatus in which: a latent image is formed on a surface of an image carrier, to which surface a photosensitive material is applied, by performing light scanning by laser light for example using a light scanning apparatus; toner is adhered on the latent image using a development apparatus; and then, the toner is transferred to a transfer material using a transferring apparatus to form an image. In the electrophotographic method, color image formation is performed by overlapping monochrome toner images of cyan (C), magenta (M), yellow (Y) and black (K). As a typical method thereof, there are known two methods of “a four-rotation method” in which the color image formation is performed by repeating the steps of forming each monochrome toner image on a single image carrier and transferring the image to recording paper of a transfer material or an intermediate transfer element, and “a tandem method” in which the color image formation is performed by providing four image carriers, forming monochrome toner images separately thereon, and overlapping those on the same transfer material. In the two methods, the tandem method is more suitable for speedup since the color image formation is completed by one step, and thus the demand for the tandem method is increasing in accordance with increase of office document colorization.

However, since the tandem type of apparatus must equip an image carrier, an electrostatic charge apparatus, a development apparatus and a cleaning apparatus for each color, the apparatus tends to be larger. Especially in a configuration of the apparatus widely used in the past, the image carriers are arranged horizontally, and the development apparatus are disposed generally beside the image carriers. Thus, there has been a restriction to reduce a distance between the image carriers.

As a technique for solving this problem, there is known an apparatus of which the image carriers are arranged vertically, the development apparatus being arranged in a horizontal direction with respect to the image carriers, so that the distance between the image carriers is reduced to realize miniaturization, as shown in JP-A-10-48898 (page 2 and FIG. 1) and JP-A-2001-134042 (page 2 and FIG. 1), for example.

### BRIEF SUMMARY OF THE INVENTION

However, there has been the following problem in order to realize the miniaturization further from the above-mentioned configuration disclosed in JP-A-10-48898.

Light scanning irradiation on a surface of an image carrier needs to be performed almost vertically thereon to obtain a good spot shape. Thus, in order to achieve the good spot shape in the configuration disclosed in JP-A-10-48898, the scanning light on the image carrier must be irradiated so as to be coincide approximately with a straight line which passes through the center of the image carrier and is vertical to an arranged direction of the image carriers. However, the configuration involves a restriction that the development apparatus cannot be disposed on the above described straight line.

On the contrary, according to the configuration disclosed in JP-A-2001-134042, a light scanning apparatus is placed between the development apparatuses, and a scanning light reflecting mirror inside the light scanning apparatus is placed in the vicinity of the image carrier to increase a degree of freedom of an incident direction of the scanning light. However, the configuration has a problem that a distance between the image carriers is restricted due to the thickness of the light scanning apparatus itself. Also, since a relative position between the reflecting mirror and the image carrier is defined by a body frame to which the reflecting mirror and the image carrier are fixed, when the body frame is deformed due to influence of change of load, internal temperature or the like, there is a possibility that change of the relative position may cause a color shift. To prevent the color shift, there are known a mechanical correction means such as a reflecting mirror angle adjustment, and an electrical correction means such as a write timing adjustment, however, the both of those have problems that the cost is increased, and that it is difficult to identify a color shift factor when the position change of each of the image carrier and the reflecting mirror is generated independently, which problem makes a correction operation more complicated.

Accordingly, it is an object of the present invention to provide an image forming apparatus capable of solving the above problems and achieving both of miniaturization and high image quality with a simple configuration.

The above problems can be solved by placing a reflecting mirror in the vicinity of an image carrier, and mounting the image carrier and the reflecting mirror on a common supporting member to constitute the reflecting mirror and the image carrier as a single unit while a light scanning apparatus is constituted as a different unit from the above described unit. By the configuration, it becomes possible to offset scanning light, which is approximately perpendicular to an arranged direction of the image carriers, with respect to the center of the image carrier as much as a predetermined amount, and thus a development apparatus can be disposed on the above-described straight line, so that a distance between the image carriers is reduced. Further, by mounting the image carrier and the reflecting mirror on the common supporting member, a relative position therebetween is defined by the common member, so that a color shift is prevented. Furthermore, by constituting the light scanning apparatus as a different unit from the unit including the image carrier and the reflecting mirror, it becomes possible to increase a degree of freedom of design, and prevent the apparatus from becoming larger.

Other objects, characteristics and advantages of the present invention will be clarified by the following description of embodiments of the present invention relating to the attached drawings.

Hereinafter, the embodiments of the present invention will be described by referring to the drawings.

### BRIEF DESCRIPTION OF THE SEVERAL VIEWS OF THE DRAWINGS

FIG. 1 shows a supporting member for supporting a pair of an image carrier and a reflecting mirror;

FIG. 2 shows a supporting member for supporting a plurality of image carriers and reflecting mirrors;

FIG. 3 shows another configuration of the supporting member for supporting a pair of an image carrier and a reflecting mirror;

FIG. 4 shows another configuration of the supporting member for supporting a plurality of image carriers and reflecting mirrors;

FIG. 5 shows a fixing means of the reflecting mirror;

FIG. 6 shows an incident direction of scanning light on the image carrier;

FIG. 7 shows an overall configuration of an image forming apparatus comprising a single optical deflector according to the present invention; and

FIG. 8 shows an overall configuration of an image forming apparatus comprising a plurality of optical deflectors according to the present invention.

### DETAILED DESCRIPTION OF THE INVENTION

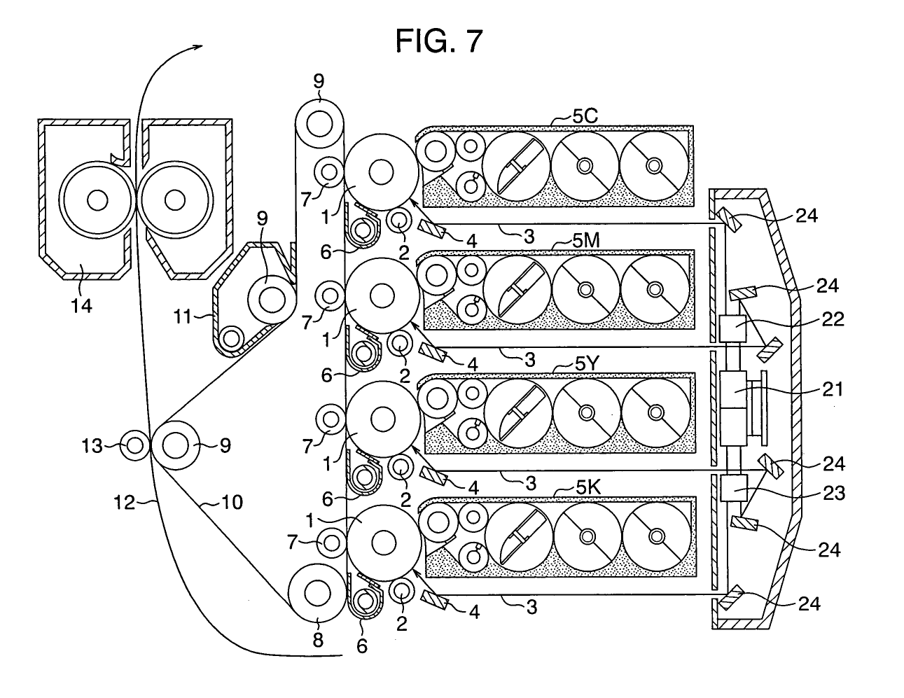

FIG. 7 shows a whole configuration of an image forming apparatus according to an embodiment of the present invention.

This image forming apparatus is provided with a plurality of photo conductors 1 which are the image carriers, the photo conductor being arranged in a row. On one side of the row of the photo conductors, there are provided a transfer apparatus 7, and an intermediate transfer belt 10 which is a transfer material installed around the transfer apparatus 7, a driving roller 8 and an idle roller 9. On the other side of the row, there are provided development apparatuses 5C, 5M, 5Y and 5K. Further, on the back side of the development apparatuses 5C, 5M, 5Y and 5K, there is placed a light scanning apparatus 20 provided with a single optical deflector 21.

According to this image forming apparatus, color image formation is performed as follows. Firstly, a surface of the photo conductor 1 which is the image carrier is electrically charged by a charging apparatus 2. Next, scanning light corresponding to image data is irradiated on the surface of the image carrier by the light scanning apparatus 20, and a latent image is formed on the photo conductor 1 by removing the electric charge of a portion on which the scanning light is irradiated. Visible toner of cyan is adhered to this latent image position by the development apparatus 5C to form a monochrome visible image, and then the visible toner image is transferred to the intermediate transfer belt 10 of a transfer material by the transfer apparatus 7. The other monochrome images are also formed in the same step with respect to magenta (M), yellow (Y) and black (K), and then those are overlapped on the intermediate transfer belt 10 so as to form a color toner image. The color toner image on the intermediate transfer belt 10 is transferred on recording paper moving along a paper route 12 by a transfer apparatus 13, and is then fused and permeated so as to be fixed on the paper by a fixing apparatus 14, so that the color image formation is completed.

When irradiating the scanning light in the above described image formation process, a scanning light 3 which is the light emitted from a laser light source (not shown) is scanned by the optical deflector 21, passes through an fθ lens and a reflecting mirror 24, and is then directed in a direction approximately vertical to an arrangement direction of the photo conductors. Thereafter, as shown in FIG. 6, the direction of the scanning light 3 is changed by a reflecting mirror 4 placed in the vicinity of the photo conductor 1, and becomes incident in a direction approximately coincident with a normal line on the surface of the photo conductor 1. In this case, in order to prevent the scanning light from going backward on the same optical path by being reflected by the surface of the photo conductor 1, it is desirable to provide an offset within a range of ±5 degrees with respect to the surface normal line of the photo conductor 1. This should be applied also to the development apparatuses 5M, 5Y and 5K.

According to this configuration, it is possible to place the development apparatus in a portion which has been normally used as a passage route of the scanning light by placing the reflecting mirror in the vicinity of the image carrier, so that the arrangement distance of the photo conductors can be reduced.

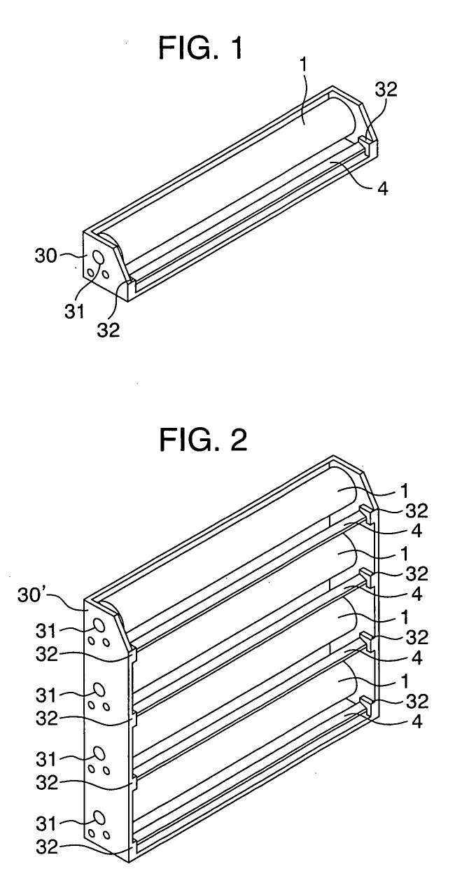

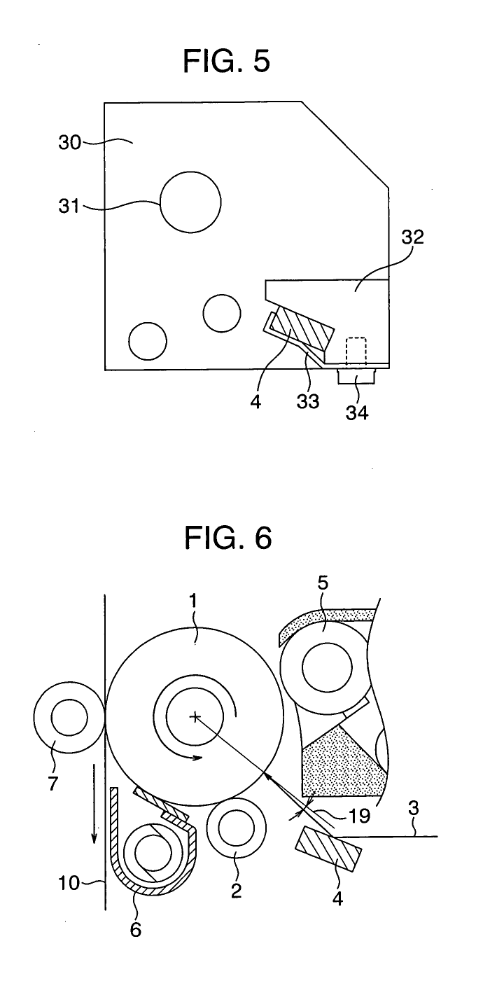

Also, in the image forming apparatus, the photo conductor 1 and the reflecting mirror 4 are supported by a common supporting member 30 as shown in FIG. 1. The reflection mirror 4 is mounted on a mounting portion 32 in a shape shown in FIG. 5 via a pressure member 33 which is an elastic body and via a fastening member 34. The photo conductor 1 is supported by a bearing 31. That is, the reflecting mirror 4 and the photo conductor 1 are constituted as the single unit. In this case, the light scanning apparatus 20 is constituted as a different unit from the unit of the reflecting mirror 4 and the photo conductor 1. According to this configuration, since there is no independent position change of the photo conductor 1 and the reflecting mirror 4 even if deformation of a housing or the like occurs, at least a color shift due to a relative position change between the photo conductor 1 and the reflecting mirror 4 is prevented, and is becomes easy to apply a mechanical color shift correction means such as an angle adjustment of the mirror 24 and an electrical color shift correction means such as a write timing adjustment. Also, it is possible to obtain a high degree of freedom of design and to prevent the apparatus from becoming larger, by constituting the light scanning apparatus 20 as a different unit from the unit of the photo conductor 1 and reflecting mirror 4.

The image carrier 1 and the reflecting mirror 4 supported by the common supporting member do not necessarily have to be constituted as a pair, and it is possible to mount a plurality of photo conductors 1 and a plurality of reflecting mirrors 4 on a common supporting member 30′ as shown in FIG. 2. In this case, the configuration is further advantageous for preventing a color shift because the relative positions of the image carriers 1 and the reflecting mirrors 4 are defined by the same member.

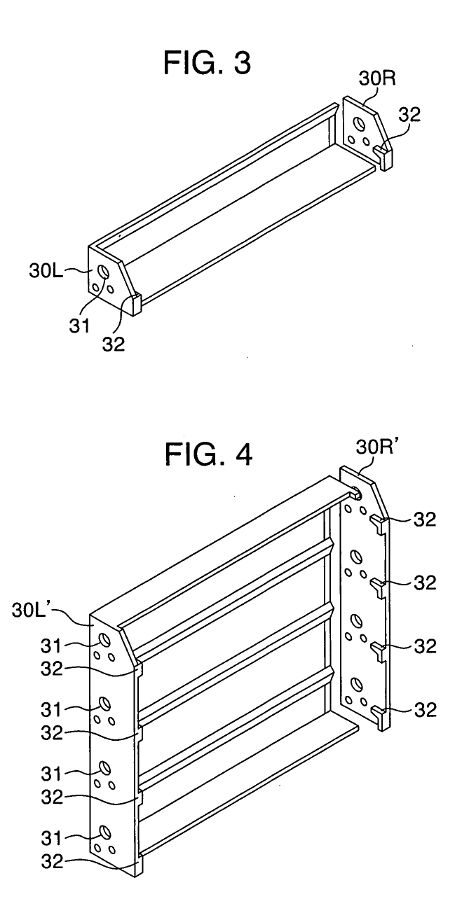

FIG. 1 shows the supporting member which is integrally formed. However, as shown in FIG. 3, it is also possible to divide the supporting member into a member 30L for supporting both of one ends of the image carrier and the reflecting mirror, and a member 30R for supporting both of the other ends thereof to facilitate assembly. In the same manner, it is possible to take the configuration shown in FIG. 4 in the case of supporting a plurality of image carriers and a plurality of reflecting mirrors in common.

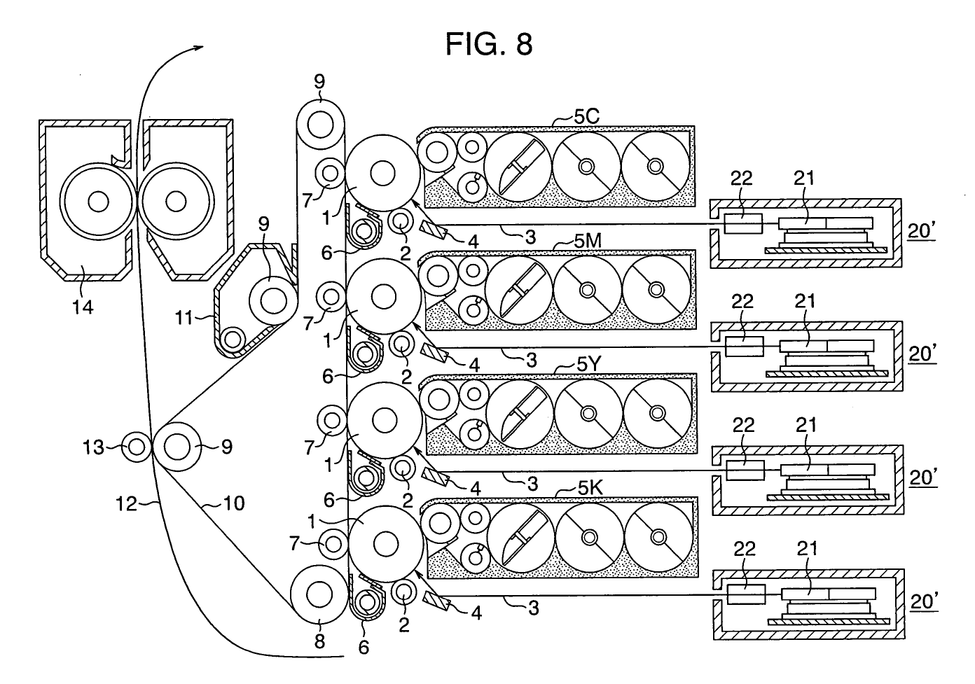

The image forming apparatus according to the present invention is not limited to the configuration comprising a single optical deflector, but may have a configuration comprising a plurality of optical deflectors as shown in FIG. 8. Each of FIGS. 7 and 8 shows the configuration comprising an intermediate transfer element as a transfer material for transferring the toner images from the photo conductors. However, it may also be possible to take the configuration which uses recording paper directly as a transfer material. Furthermore, the arrangement direction of the photo conductors cannot be limited to a vertical direction, but it is also possible to take the configuration having any other arrangement direction.

According to the present invention, it is possible to achieve both of miniaturization and higher image quality by a simple configuration in a tandem color image forming apparatus comprising a plurality of image carriers.

It should be further understood by those skilled in the art that although the foregoing description has been made on embodiments of the invention, the invention is not limited thereto and various changes and modifications may be made without departing from the spirit of the invention and the scope of the appended claims.

1. An image forming apparatus comprising:
an image carrier having a photosensitive material on a surface thereof;
a light scanning apparatus for irradiating scanning light on the image carrier in accordance with image information; and
a scanning light reflecting mirror for changing a traveling direction of the scanning light, wherein
said scanning light reflecting mirror and said image carrier are mounted on a common supporting member to constitute a first unit, and said light scanning apparatus is built into a second unit separate from the first unit.

2. The image forming apparatus according to claim 1, comprising a plurality of image carriers arranged in a row, and a plurality of development apparatuses provided to the respective image carriers so as to be substantially perpendicular with respect to a direction of the row of the plurality of image carriers, wherein
said light scanning apparatus is disposed on the opposite side of said development apparatuses to said image carriers, so that said scanning light is irradiated from said light scanning apparatus on said scanning light reflecting mirror through a space between said plurality of development apparatuses.

3. The image forming apparatus according to claim 1, comprising a plurality of image carriers, and a plurality of scanning light reflecting mirrors corresponding to the plurality of image carriers, wherein
said plurality of image carriers and said plurality of scanning light reflecting mirrors are supported by the common supporting member so as to constitute said first unit.
